(19) United States
(12) Patent Application Publication
(10) Pub. No.: US 2006/0111471 A1
(43) Pub. Date: May 25, 2006

(54) Impact resistant PVC formulations and methods of manufacturing thereof

(76) Inventors: Tonia Boutelle, Sandersville, GA (US); Joel Zazyczny, Alpharetta, GA (US); Jason Prince, Sandersville, GA (US); Gary Mobley, Tennille, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/262,942

(22) Filed: Nov. 1, 2005

Related U.S. Application Data
(60) Provisional application No. 60/623,250, filed on Nov. 1, 2004.

(51) Int. Cl. C08K 9/12; C08K 3/26

(52) U.S. Cl. 523/210; 524/425

(57) ABSTRACT

Disclosed herein is a method of making a rigid polymer product, such as an impact resistant halogen containing polymer, comprising adding to a halogen containing resin at least one mineral filler comprising coated calcium carbonate having a hydrophobic coating derived from at least one aliphatic carboxylic acid comprising at least 10 carbon atoms in the main chain, and no more than 0.01% by weight of agglomerates or particles having a particle size greater than 44 μm. Further disclosed herein are rigid polymer products comprising this coated calcium carbonate for use in applications that benefit from impact resistant properties, such as vinyl siding and PVC pipes and fittings.

This application claims priority to U.S. Provisional Patent Application No. 60/623,250, filed Nov. 1, 2004.

Disclosed herein are filled polymer compositions and end-products comprising halogen containing polymers and calcium carbonate treated with at least one aliphatic carboxylic acid comprising at least 10 carbon atoms in the main chain. Also disclosed herein is a method of making filled halogen containing polymers, such as polyvinyl chloride (PVC) polymers including rigid and impact resistant PVC polymers. Further disclosed herein is a method of manufacturing such products, including vinyl siding and PVC pipes, using the filled, impact resistant PVC polymers.

Alkaline earth metal carbonates, such as calcium carbonates, are often used as a particulate filler in polymer products. In the polymer products, fillers, which are relatively inexpensive, can serve to replace a portion or extend the use of expensive polymer resins. However, conventional fillers suffer from problems associated with the presence of relatively large agglomerates. The presence of large agglomerates may be due to insufficient coating and/or the presence of high content of moisture within the filler, and can result in greater failure rates during the production of polymer products.

Impact resistant PVC polymers can be used in various applications, such as vinyl siding and construction materials. Conventional fillers have failed to be used to replace a portion or extend the use of expensive PVC polymer resins without compromising the properties, such as impact resistance, of the final PVC product, due to, for example, high agglomerate level of the fillers.

Therefore, there remains a need to find fillers which can serve to replace a portion or extend the use of PVC polymer resins or to decrease the amount of impact modifiers used, without compromising the properties, such as impact resistance, of the final PVC product.

The present inventors have surprisingly found that an impact resistant polymer can be obtained by adding into the polymer resin a calcium carbonate having a low agglomerate level, such as no more than about 0.01% for agglomerates or particles with a size of greater than 44 μm. In one embodiment, the calcium carbonate having such agglomerate levels may be used in PVC formulations, such as in formulating impact resistant PVC polymer products, for example, vinyl sidings and PVC pipes.

Accordingly, one aspect of the present disclosure relates to a method of making a filled polymer product, such as an impact resistant PVC polymer, comprising adding to a PVC resin a calcium carbonate having an agglomerate or oversized particle level (defined as greater than 44 μm) of no more than about 0.01%, further such as no more than 0.007%, and even further such as no more than 0.005%. In one embodiment, the calcium carbonate as disclosed herein has the aforementioned agglomerate or oversized particle level of no more than 0.003%.

As used herein, the term “resin” means a polymeric material, either solid or liquid, prior to shaping into a plastic article. The at least one polymer resin used herein is one which can be formed into a plastic material.

As used herein, the term “agglomerate” is given its ordinary meaning of one or more particles that are clustered, bonded, or otherwise joined together. The term “low agglomerate or oversized particle level” means low levels of particles or agglomerates having a size of greater than about 44 μm, such as from 50 to 200 μm. The agglomerate level can be measured by any ordinary method known to one of ordinary skill in the art.

As disclosed herein, the agglomerate level is determined as follows. The calcium carbonate as disclosed here is slurried in an aqueous organic solution comprising 100 ml of water and 300 ml of isopropanol using a Hamilton Beach mixer at medium setting and rheostat on 120 V for 10 minutes. The slurry is poured through a 325 mesh sieve and the sieve is washed with pressure spray set on 32 psi until water passing the sieve is clear. The residue from the sieve is dried. The agglomerate level is calculated as percentage of the weight of the dried residue divided by the dry weight of the calcium carbonate.

The calcium carbonate as disclosed herein can have a +325 mesh residue level of, for example, no more than 0.01%, such as no more than 0.005%, and further such as no more than 0.003%. The +325 mesh residue level of the calcium carbonate disclosed herein is measured according to ASTM D1514, which is the percentage of material retained on a 325 U.S. mesh (44 μm aperture) screen after water washing.

The calcium carbonate as disclosed herein can have a +500 mesh residue level of, for example, no more than 0.005%, such as no more than 0.003%, and further such as no more than 0.002%. In one embodiment, the calcium carbonate as disclosed herein has a +500 mesh residue level of no more than 0.0015%. The +500 mesh residue level of the calcium carbonate disclosed herein is measured according to ASTM D1514, which is the percentage of material retained on a 500 U.S. mesh (25 μm aperture) screen after water washing.

The calcium carbonate as disclosed herein can have a top size (also called “top cut”) of, for example, no more than 10 μm, such as no more than 8 μm. The term “top size” or “top cut” means the particle size value wherein at least 99% by weight of the particles of the material are less than that size. The particles sizes, including the particle size distribution (PSD), of the uncoated calcium carbonate can be determined by measuring the sedimentation of the calcium carbonate in a fully dispersed condition in a standard aqueous medium, such as water, using a SEDIGRAPH™ instrument, e.g., SEDIGRAPH 5100, obtained from Micromeritics Corporation, USA. The particles sizes, including the PSD, of the coated calcium carbonate as disclosed herein can be determined by using Microtrac® X100. The “particle size” of a given particle is expressed in terms of the diameter of a sphere of equivalent diameter, which sediments through the medium, i.e., an equivalent spherical diameter (ESD).

The median particle size (D₅₀) of the calcium carbonate as disclosed herein can be, for example, no more than 2 μm, such as no more than 1 μm, and further such as no more than 0.7 μm. In one embodiment, the median particle size (D₅₀) ranges from 0.5 to 1.5 μm.

The calcium carbonate as disclosed herein can also, for example, have a Hunter brightness of no less than 90. Desirably, the calcium carbonate will have a relatively high brightness and a relatively low yellowness. The brightness can be determined using a method known in the art. As disclosed herein, the brightness of the calcium carbonate is determined using a Technidyne TB-1C Brightness Meter following a TAPPI brightness procedure.

In addition, the calcium carbonate as disclosed herein can have a minimal total surface moisture content. In one embodiment, the calcium carbonate may have a total surface moisture content of less than 0.1%. The total surface moisture level may be measured in a known manner, such as by a Karl Fischer titration apparatus or by a microbalance. The total surface moisture content as disclosed herein is determined using Computrac Max 2000 moisture analyzer and weight loss method.

The calcium carbonate as disclosed herein can also have a minimal moisture pick up. For example, the calcium carbonate has moisture pick up of less than 0.35% by weight, such as less than 0.2% by weight, and further such as less than 0.1% by weight relative to the total weight of the calcium carbonate. The moisture pick up as disclosed herein is measured by placing dried calcium carbonate samples into a 97% relative humidity desiccator for 24 hours and then measuring the weight gain via a Computrac® moisture meter.

The calcium carbonates used herein may be obtained from a natural source, e.g., marble, chalk, limestone, and dolomite. Calcium carbonate obtained from a mineral source can be processed by refining and treatment processes including grinding to obtain a suitable particle size distribution. The grinding process may be carried out by dry grinding or by grinding in an aqueous medium in which any dispersant employed is minimized and/or subsequently removed from the filler in a known manner. Wet ground material is subsequently dried to an extent such that the resulting calcium carbonate has an appropriate moisture content.

In one embodiment, the calcium carbonate as disclosed herein, can be surface treated with at least one aliphatic carboxylic acid comprising at least 10 carbon atoms in the main chain, such as stearic acid, behenic acid, palmitic acid, arachidic acid, montanic acid, capric acid, lauric acid, myristic acid, isostearic acid and cerotic acid and mixtures thereof. The surface treatment renders the calcium carbonate hydrophobic.

Conventionally, the calcium carbonates are screened prior to coating to remove large or oversized particles which are believed to interfere with the production of the final products such as polymer products. Large or oversized particles are those particles or agglomerates having a size greater than about 44 μm. In addition, the calcium carbonate are usually screened again after coating to remove large agglomerates which are also believed to interfere with the production of the final products.

The processing methods employed for producing the surface coated calcium carbonate as disclosed herein can be chosen from many procedures known to those skilled in the art and coupled with a classification and/or a milling process to produce calcium carbonate having a low agglomerate level, such as an agglomerate level of no more than 0.01%.

In one embodiment, the process includes comminution of the starting material, e.g., calcium carbonate, by wet grinding. Any dispersant employed can be minimized or removed. Alternatively, grinding may be carried out by a known dry grinding process.

The wet processing of calcium carbonate, when employed, may be done either by ball milling and/or by stirred media grinding. Stirred media grinding uses hard, e.g., ceramic or graded sand, and the media usually have particles larger than the particles to be ground. Usually stirred media grinding starts with a finer feed from a classification operation.

Where a wet grinding process is employed as disclosed herein, the amount of water soluble hydrophilic dispersant remaining following grinding is, for example, not greater than about 0.05% by weight relative to the dry weight of the calcium carbonate.

The wet processed ground calcium carbonate may be washed and dewatered in a known manner, for example, by flocculation, filtration or forced evaporation, prior to drying. A polyelectrolyte might be added in small quantities where it is to be used to flocculate the mineral for ease of dewatering, but the amount of such polyelectrolyte is, for example, not greater than about 0.05% by weight based on the dry weight of the calcium carbonate.

Following grinding, the calcium carbonate may be dried by removing water to leave no more than about 0.2% (such as less than about 0.1%) by weight of total surface moisture content, relative to the dry weight of the calcium carbonate. This drying procedure may be carried out in a single step or in at least two steps, for example, by applying a first heating step to the calcium carbonate to enable the adhered moisture content to be reduced to a level which is not greater than about 0.2% by weight based on the dry weight of the calcium carbonate; and applying at least a second heating step to the calcium carbonate to reduce the total surface moisture content thereof to 0.1% by weight or less. The second heating step may be applied before and/or during the surface treatment. The second heating step may suitably be carried out by an indirect heating methods as discussed later. The first heating step may be by a direct or indirect heating methods.

Where the drying of the surface of the calcium carbonate is carried out by more than one heating step, the first heating step may be carried out by heating in a hot current of air. For example, the calcium carbonate is dried in the first heating step to an extent that the adsorbed moisture content thereof is less than about 0.2% by weight, such as less than about 0.1% by weight based on the dry weight of the calcium carbonate.

The ground calcium carbonate may be further dried in the second heating step prior to or during a surface treatment of the carbonate to the extent that the adsorbed moisture content thereof is, for example, not greater than about 0.1% by weight, such as not greater than about 0.085% by weight, based on the dry weight of the calcium carbonate.

In one embodiment, the calcium carbonate is preheated prior to being subjected to the surface treatment.

While the calcium carbonate may be heated during the coating process, the residence time is very short and therefore, the time available to heat the calcium carbonate during coating is very short. In addition, the calcium carbonate is stored prior to introducing into the coating apparatus, thus allowing the calcium carbonate to cool down from the deviated temperature it achieved during the drying process. During this cooling period there is a possibility of moisture condensation on the calcium carbonate. Not wishing to be bound by theory, it is believed that this moisture can inhibit the efficient coating of the calcium carbonate. Therefore, removing any moisture that condensed between the period the calcium carbonate was dried and the coating process by preheating prior to coating is recommended.

The surface treatment of the calcium carbonate is, for example, carried out in a dry atmosphere. The surface treatment agent used can be as a liquid (e.g., as droplets) in a vessel heated indirectly, for example, by a heating jacket containing a heating fluid, such as heating oil.

As described in U.S. Pat. No. 6,682,775 B2, the temperature of the atmosphere in the vessel is varied and controlled so that a selected atmosphere reaction temperature may be chosen and monitored. The vessel may comprise an elongated heated cylindrical structure. In one embodiment, the temperature is maintained throughout the region where the surface treatment agent is applied and exits from that region at about 80° C., such as about 120° C. or higher, and further such as about 150° C. or higher. It is theorized that low adsorbed moisture content of, for example, below 0.1%, can be attained on the surface treated calcium carbonate surface using indirect heating in this way since the calcium carbonate being indirectly heated is not exposed to any combustion byproducts from a heating furnace, such as water, which would be the instance if a direct heating system were used. A direct heating system generally involves the use of a vessel heated with flue gases which creates an atmosphere of gases including water vapors that can increase the moisture content of the surface of the calcium carbonate in the vessel. Most conventional ground calcium carbonates are heated and surface treated through this direct heating system described hereinbefore. As described earlier, a direct heating system can be employed in the first step to remove most of the surface moisture, for example, to a level of not greater than about 0.2% by weight, based on the dry weight of the calcium carbonate, and, thereafter, in the second step an indirect heating system is, for example, used to avoid the introduction of moisture by the heating.

The average temperature at which the calcium carbonate is treated with the surface treatment agent may, for example, range from 80° C. to 300° C., such as from 120° C. to 180° C. with a residence time of the calcium carbonate in the vessel being greater than about 2 seconds. The residence time may range, for example, from about 50 seconds to 1000 seconds, such as from 50 seconds to 500 seconds.

In one embodiment, the surface treatment agent is chosen from stearic acid and a mixture of fatty acids comprising stearic acid, for example, technical grade stearic acid which typically comprises about 65% by weight of stearic acid and about 35% by weight of palmitic acid. Other unsaturated fatty acids which may be used herein may be chosen from capric acid, lauric acid, montanic acid, myristic acid, isostearic acid and cerotic acid and mixtures thereof.

The surface treatment agent is, for example, a hydrophobizing agent which can be bonded (or chemisorbed) on the calcium carbonate particles in order to facilitate dispersion of the calcium carbonate in polymers. For example, stearic acid reacts with calcium carbonate to form a chemisorbed coating of calcium stearate thereon. Such a coating can give superior properties to calcium stearate pre-formed as a compound and typically deposited on the calcium carbonate.

In one embodiment, the amount of surface treatment agent which is present in the heated atmosphere in which the calcium carbonate is to be contacted by and treated with the agent is not substantially greater than the maximum theoretical amount of the agent which can become bonded by chemisorption to the calcium carbonate. This maximum theoretical amount is dependent on the surface area of the particles of the calcium carbonate. The theoretical surface coverage S by the surface treatment agent is given by the equation:
S=MₐNAₐ (1)

wherein Mₐ is the number of moles of the surface treatment agent present, Aₐ is the surface area occupied by 1 molecule of the surface treatment agent, and N is Avagadro's number. Using Equation (1), it can be shown for example that 1 g of technical grade stearic acid (comprising about 65% by weight of stearic acid and about 35% by weight of palmitic acid) covers about 4.60 m² of the surface of a calcium carbonate. Thus, for a calcium carbonate having a surface area of about 4.60 m².g⁻¹, about 0.01 g of surface treatment agent is needed to give a complete coverage of the surface area of each 1 g of calcium carbonate.

Thus, the required theoretical maximum concentration of the surface treatment agent for a calcium carbonate particulate material having a surface area of 4.60 m²/g is 1.0% based on the weight of the particulate material to be treated. In practice, the amount of surface treatment agent which becomes bonded to (i.e., chemisorbed onto) the particulate material is less than about the theoretical maximum, although by carrying out the surface treatment at a higher temperature than conventionally employed, as described hereinbefore, the amount can approach closer to the theoretical maximum and the amount of remained undesirable unreacted (physisorbed) surface treatment agent can thereby be advantageously minimized.

In addition, the concentration of surface treatment agent present in the atmosphere in which the calcium carbonate is to be surface treated by the agent is not substantially greater than about X % by weight based on the weight of calcium carbonate, wherein X is given by
X=T+U (2)

wherein T is the theoretical amount of the agent needed to cover the surface area of the calcium carbonate and U is the amount of unreacted surface treatment agent (% by weight based on the dry weight of the calcium carbonate) obtained when the calcium carbonate is in fact treated by the agent under the treatment conditions employed, which may be determined from a previous treatment run under the same conditions. For example, the concentration of the applied surface treatment agent may range from about 0.8× to about 1.0×.

The amount of surface treatment agent required depends on the surface treatment agent employed, as explained earlier. For an agent comprising at least 60% by weight of stearic acid, for example, the amount can range, for example, from about 1.0% by weight to about 1.4% by weight based on the dry weight of the calcium carbonate. In one embodiment, the surface treatment agent, i.e., the at least one aliphatic carboxylic acid, is present in an amount (i.e., treatment level) ranging from 0.8% to 1.3% by weight relative to the dry weight of the calcium carbonate.

When used as a filler in polymer products, the low-agglomerate coated calcium carbonate can improve the impact resistance of the polymer products in comparison to polymer products filled with uncoated calcium carbonate having a higher agglomerate level. In addition, when the calcium carbonate is mixed with a PVC resin, the fusion behavior of the rigid PVC blends can be affected by the agglomerate level of the calcium carbonate.

The calcium carbonate as disclosed herein is dried so that its total surface moisture level does not exceed 0.1% by weight, such as less than about 0.085% by weight, based on the dry weight of the treated calcium carbonate. In one embodiment, the total surface moisture level is within these limits both immediately preceding and following the surface coating. The total surface moisture level may be measured in a known manner, such as by a Karl Fischer titration apparatus or by a microbalance. As discussed above, the total surface moisture content as disclosed herein is measured using Computrac Max 2000 moisture analyzer and weight loss method.

After the coating treatment, the coated calcium carbonate may be subject to a classification and/or a milling process. Apparatus for classification and for milling are both readily apparent to the skilled artisan and could be appropriately selected. Classification can be carried out by, for example, air classification, or mechanical separation using, for example, a table separator or screen. External classifiers are available from Progressive Industries or RSG. Milling apparatus that would be appropriate for use herein include micropulverizers, pebble mills, ultrafine media mills, cell mills, disk mills and pin mills. In one embodiment, air classifier mills (ACMs) are used. As alternatives to the ACM produced by Hosokawa Micron of Summit, N.J., there are other apparatus that can function in a similar manner to classify and mill the calcium carbonate particulate in a single operation. These alternatives include, for example, a CMT and a Sturtevant Powderizer.

An alternative approach is the Cell Mill type where there are also designs from Altenberger, Bauermeister and Ultra Rotor. None of these machines is fitted with an integral classifier with a throw-out, although the Bauer Mills are fitted with a rudimentary throw-out device.

In one embodiment, the coated calcium carbonate particulates are subject to both classifying and milling processes. Both classifying and milling processes may be carried out in a single apparatus. In this embodiment, the coated calcium carbonate particulates, after the coating processes, are subjected to classification. The interfering particles, i.e., oversized particles and/or agglomerates having a size over 44 μm, are then subjected to milling. Milling is not carried out to grind the coated calcium carbonate finer since that would take a considerable amount of energy, although such grinding is not precluded; milling is, for example, used to break down the interfering particles, agglomerates or particles that have been bonded or stuck together. Once the interfering particles are broken down the milled material is returned to the classifier which again separates any remaining interfering particles and again sends the stream of interfering particles to be milled. This is one example of a continuous production loop, however, this process may be carried out in batches as appropriate.

In another embodiment, the coated calcium carbonate particulates may be classified to remove the interfering particles and also beneficially, certain discrete particles and this waste stream may then be discarded. This process while producing a further improved product has certain economic disadvantages over the milling process as discussed above due to the loss of materials associated with discarding the waste stream.

For example, the coated calcium carbonate particulates as disclosed herein are chosen from ground calcium carbonate particulates produced by either a dry grinding process or a wet grinding process as described above.

By using the processes discussed above, one skilled in the art can consistently obtain coated calcium carbonates having a low agglomerate level, such as no more than 0.01%.

The present inventors have surprising found that the use of the calcium carbonate having at least one of the properties: a low agglomerate level, a low +325 mesh residue level, a low +500 mesh residue level, and low total surface moisture content, such as the coated calcium carbonate, as disclosed herein can improve the quality and properties of the final products in which it is used and enhance the process of making these products. For example, the calcium carbonate disclosed herein can be easily dispersed into polymer systems, thereby leading to higher loadings of the calcium carbonate while maintaining its ability to be processed into useful impact resistant polymer.

In one embodiment, the loading of the calcium carbonate as disclosed herein in a PVC polymer formulation is 75% by weight relative to the total weight of the PVC polymer formulation. Even at such loading levels, the calcium carbonate disclosed herein possesses superior extrusion performance.

Further disclosed herein is a method of making a PVC polymer product, comprising

mixing the calcium carbonate as disclosed herein with a PVC resin; and

forming a polymer product.

The loading of the calcium carbonate as disclosed herein in the PVC resin may be, for example, at least 10% by weight, such as at least 20% by weight, further such as at least 40% by weight and even further such as at least 75% by weight relative to the total weight of the PVC polymer formulation.

The mixing can be performed in a suitable compounder/mixer, for example, a Wellex mixer, a Henschel mixer, a super mixer, a tumbler type mixer and the like.

The operation of forming the polymer product can be achieved by any method known to the skilled artisan in the art. For example, it can be achieved by using an extruder, such as a single screw extruder and a twin-screw extruder.

The polymer product as disclosed herein includes, for example, extruded products, such as vinyl siding. In addition, the polymer products as disclosed herein can have a thickness of, for example, no more than 0.1 inches, such as no more than 0.07 inches, further such as no more than 0.06 inches, and even further such as no more than 0.05 inches. In one embodiment, the polymer products as disclosed herein have a thickness of no more than 0.04 inches.

In addition to the calcium carbonate as disclosed herein and the PVC resin, the mixture to be blended by compounding may further comprise at least one additional ingredient chosen, for example, from impact modifiers, such as acrylic, methacrylate-styrene-butadiene, and chlorinated polyethylene based impact modifiers; bonding agents, plasticisers, lubricants, stabilizers, anti-oxidants, ultraviolet absorbers, dyes, and colorants. In one embodiment, the mixture further comprises at least one impact modifier in an amount ranging from 1 phr to 6 phr. The at least one additional ingredient can also be used in the method of making a PVC polymer as discussed above.

Further disclosed herein is a PVC polymer formulation, comprising the calcium carbonate as disclosed herein and a PVC resin. The PVC polymer formulation can further comprise the at least one additional ingredient as discussed above. Even further disclosed here is the use of the PVC polymer formulation in making PVC polymer products, such as impact resistant PVC polymer products. Non-limiting examples of such impact resistant PVC polymer products include vinyl siding and construction materials.

The present invention is further illuminated by the following non-limiting examples, which are intended to be purely exemplary of the invention.

### EXAMPLES

### Example 1

A calcium carbonate treated with stearic acid having an agglomerate level of less than 0.01% according to the present invention (“inventive calcium carbonate”) was used in comparison with a commercial calcium carbonate particulate having an agglomerate level of more than 0.01% not in accordance with the present invention (“comparative calcium carbonate I”) in replacing or extending a portion of a PVC resin in an impact resistant PVC polymer formulation. The comparative calcium carbonate I has been used commercially as a filler in forming rigid PVC polymers.

The inventive calcium carbonate has a +500 mesh residue level of less than 0.002%; while the comparative calcium carbonate I has a +500 mesh residue level of more than 0.005% (not in accordance with the present invention). Further, the inventive calcium carbonate comprises 95% by weight of calcium carbonate relative to the total weight of the inventive calcium carbonate and has a coating level ranging from 0.9% to 1.15% by weight relative to the weight of the calcium carbonate. It further has a moisture pick up of less than 0.2% by weight, relative to the total weight of the coated calcium carbonate, a +325 mesh residue level of less than 0.005%, a mean particle size (D₅₀) of less than 2 μm, a top size of less than 10 μm, and a brightness of more than 90.

The following PVC polymer formulations were prepared:

| | Inventive PVC | Comparative |
|---|---|---|
| | Polymer Formulation | PVC Polymer |
| | (in accordance | Formulation I |
| | with the | (not in accordance with |
| Ingredients | invention) (phr) | the invention) (phr) |
| PVC resin | 100 | 100 |
| Stabilizer | 1.0 | 1.0 |
| Calcium Stearate | 1.2 | 1.2 |
| Oxidized Polyethylene | 0.15 | 0.15 |
| Acrylic Impact | 1.5 | 1.5 |
| Modifier (Kaneka | | |
| FM40) | | |
| Parafin Wax | 1.2 | 1.2 |
| TiO₂ | 0.5 | 0.5 |
| Inventive Calcium | 10 | — |
| Carbonate | | |
| Comparative Calcium | — | 10 |
| Carbonate I | | |

The PVC resin was added into a Wellex mixture for mixing and heating. The PVC resin was heated to 100° F. and stabilizer was added. The resulting mixture was heated to 180° F. and the lubricants (i.e., calcium stearate and oxidized polyethylene) were added. The resulting mixture was heated to 200° F. and the process aids (i.e., paraffin wax) and TiO₂ were added. The resulting mixture was then heated to 210° F. and calcium carbonate, i.e., either the inventive calcium carbonate or the comparative calcium carbonate 1, was added. The resulting mixture was then compounded in a Leistritz twin-screw extruder. Samples of rigid PVC polymer strips with a thickness of 0.04 inches were obtained.

The physical properties of the resulting rigid PVC polymer strips were determined, including their optical properties, Brabender rheology, and Gardner impact at both room temperature and cold temperature (0° C.) in the same day testing (i.e., “in line” testing) and after 24 hours conditioning.

The optical properties, i.e., color, of the resulting PVC polymer samples were evaluated by using the L*a*b* system, with a HunterLab Ultrascan XE Meter. According to this system, L* indicates the lightness of the color. The lowest value L* is the most intense color of the sample. The chromaticity (luminosity) of the sample is expressed by the parameters a* and b*, a* indicating the axis of red/green shades and b* the axis of yellow/blue shades.

The Brabender rheology of the resulting PVC polymer samples were determined by equipment, such as torque rheometers made by C. W. Brabender Instruments, Inc., and methods known to skilled artisan in the art. The test was conducted at 170° F. with 50 rpm and using 70 g of the samples.

Gardner impact, i.e., falling dart impact, of the resulting PVC polymer samples were determined by equipment and methods known to skilled artisan in the art. For example, the procedures of ASTM D4226, D5420, D5628 can be followed in measuring the Gardner impact. The Gardner impact test is a traditional method for evaluating the impact strength, toughness, or resistance of a plastic material. As used herein, the procedure of ASTM D5420 was followed. The result is shown as mean failure energy in in-lb.

The results are shown in Tables 1, 2, and 3.

TABLE 1
Optical Property

| | Inventive Sample | Comparative Sample I |
|---|---|---|
| L* | 90.87 | 90.94 |
| a* | −1.30 | −1.37 |
| b* | 3.05 | 3.25 |

TABLE 2
Brabender Rheology

| | Inventive Sample | Comparative Sample I |
|---|---|---|
| Fusion Time | 62 | 62 |
| (seconds) | | |
| Maximum Torque | 2596 | 2548 |
| (mg) | | |

TABLE 3
Gardner Impact

| | Same Day Testing | | 24 Hour Conditioning | |
|---|---|---|---|---|
| | | Cold | | Cold |
| | Room | Temperature | Room | Temperature |
| | Temperature | (0° C.) | Temperature | (0° C.) |
| | (in-lb) | (in-lb) | (in-lb) | (in-lb) |
| Inventive | 79.6 | 42 | 56 | 31.6 |
| Sample | | | | |
| Comparative | 61.2 | 28.8 | 45.2 | 29.6 |
| Sample I | | | | |

As shown in Table 1, the inventive PVC polymer sample has similar optical properties as the comparative PVC polymer sample 1. In addition, as shown in Table 2, the inventive PVC polymer sample has similar Brabender rheology as the comparative PVC polymer sample 1.

However, as shown in Table 3, the inventive PVC polymer sample has higher impact resistance than the comparative PVC polymer sample I at both room temperature and cold temperature (0° C.) and during both the same day testing and after 24 hours conditioning. In addition, during the test after 24 hours conditioning, brittle break occurred in one inventive sample, compared to six brittle breaks in comparative sample 1. Therefore, the results indicate that the inventive PVC polymer using the calcium carbonate as disclosed herein as fillers has superior impact resistance than the comparative PVC polymer I using commercially available calcium carbonate fillers.

### Example 2

The inventive calcium carbonate as described in Example 1 was used in comparison with the comparative calcium carbonate 1 as described in Example 1, another commercial calcium carbonate having an agglomerate level of more than 0.01% not in accordance with the present invention (“comparative calcium carbonate 11”) in replacing or extending a portion of a PVC resin in an impact resistant PVC polymer formulation. The comparative calcium carbonate 11 has also been used commercially as a filler in forming rigid PVC polymers. In addition, a commercial PVC polymer without addition of any calcium carbonate fillers was used as control.

The PVC polymer formulations, i.e., inventive formulation, comparative formulation 1, comparative formulation 11, and control formulation, were formed as described in Example 1. In addition, another set of the PVC polymer formulations were formed including 3 phr of impact modifier, instead of 1.5 phr. Further, the PVC polymer samples, i.e., inventive sample, comparative sample 1, comparative sample 11, and control sample (i.e., without addition of any calcium carbonate fillers), were formed as described in Example 1. The physical properties of the resulting samples were determined, including their optical property, Brabender rheology and Gardner impact at room temperature and cold temperature (0° C.) after 24 hours conditioning, as described in Example 1. The results are shown in Tables 4, 5, and 6.

TABLE 4
Optical Property

| | 1.5 phr | | | 3 phr | | |
|---|---|---|---|---|---|---|
| | Impact Modifier | | | Impact Modifier | | |
| | L* | a* | b* | L* | a* | b* |
| Inventive | 94.69 | −0.67 | 2.8 | 94.98 | −0.63 | 2.87 |
| sample | | | | | | |
| Comparative | 93.95 | −0.73 | 2.26 | 94.54 | −0.7 | 2.51 |
| sample I | | | | | | |
| Comparative | 95.28 | −0.75 | 3.16 | 95.34 | −0.72 | 2.89 |
| sample II | | | | | | |
| Control | 90.48 | −1.56 | 4.39 | 90.48 | −1.56 | 4.39 |

TABLE 5
Brabender Rheology

| | |
|---|---|
| Fusion Time | Maximum |
| (seconds) | Torque (mg) |

| Impact modifier | 1.5 phr | 3 phr | 1.5 phr | 3 phr |
|---|---|---|---|---|
| Inventive | 281 | 228 | 1805 | 1809 |
| sample | | | | |
| Comparative | 281 | 219 | 1752 | 1845 |
| sample I | | | | |
| Comparative | 264 | 107 | 1798 | 1869 |
| sample II | | | | |
| Control | 205 | 205 | 1747 | — |

TABLE 6
Gardner Impact

| | |
|---|---|
| Room | Cold |
| Temperature | Temperature |
| (in-lb) | (0° C.) (in-lb) |

| Impact modifier | 1.5 phr | 3 phr | 1.5 phr | 3 phr |
|---|---|---|---|---|
| Inventive | 70 | 81.2 | 41.2 | 60.4 |
| sample | | | | |
| Comparative | 62.4 | 69.6 | 40 | 57.6 |
| sample I | | | | |
| Comparative | 58 | 62.8 | 39 | 50.2 |
| sample II | | | | |
| Control | 74.2 | 74.2 | 75.2 | 75.2 |

As shown in Table 4, the inventive PVC polymer sample has similar optical properties as comparative samples 1 and 11. In addition, as shown in Table 5, the inventive PVC polymer sample has similar Brabender rheology as the comparative samples 1 and 11.

As shown in Table 6, the inventive PVC polymer sample has higher impact resistance than both the comparative samples 1 and 11 at both room temperature and cold temperature (0° C.). In addition, the impact resistance of the inventive PVC polymer is closer to the control (i.e., without addition of any calcium carbonate fillers). Therefore, the results indicate that the inventive PVC polymer using the calcium carbonate as disclosed herein as fillers has superior impact resistance than the comparative PVC polymers 1 and 11 using commercially available calcium carbonate fillers.

Unless otherwise indicated, all numbers expressing quantities used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of making a filled polymer product comprising:
coating a calcium carbonate material with at least one aliphatic carboxylic acid comprising at least 10 carbon atoms in the main chain to form a hydrophobic coating thereon,
adding the coated calcium carbonate material to a halogen containing resin to form a filled resin,
wherein said coated calcium carbonate material has no more than 0.01% by weight of agglomerates or particles having a particle size greater than 44 μm, and
wherein said method optionally comprises forming the filled resin into a plastic product.

2. The method according to claim 1, wherein the coated calcium carbonate material has no more than 0.007% by weight of agglomerates or particles having a particle size greater than 44 μm.

3. The method according to claim 2, wherein the coated calcium carbonate material has no more than 0.005% by weight of agglomerates or particles having a particle size greater than 44 μm.

4. The method according to claim 3, wherein the coated calcium carbonate material has no more than 0.003% by weight of agglomerates or particles having a particle size greater than 44 μm.

5. The method according to claim 1, wherein the coated calcium carbonate material has a +325 mesh residue level of no more than 0.01%.

6. The method according to claim 5, wherein the coated calcium carbonate material has a +325 mesh residue level of no more than 0.005%.

7. The method according to claim 6, wherein the coated calcium carbonate material has a +325 mesh residue level of no more than 0.003%.

8. The method according to claim 1, wherein the coated calcium carbonate material has a +500 mesh residue level of no more than 0.005%.

9. The method according to claim 8, wherein the coated calcium carbonate material has a +500 mesh residue level of no more than 0.003%.

10. The method according to claim 9, wherein the coated calcium carbonate material has a +500 mesh residue level of no more than 0.002%.

11. The method according to claim 10, wherein the coated calcium carbonate material has a +500 mesh residue level of no more than 0.0015%.

12. The method according to claim 1, wherein the coated calcium carbonate material has a top size of no more than 10 μm.

13. The method according to claim 12, wherein the coated calcium carbonate material has a top size of no more than 8 μm.

14. The method according to claim 1, wherein the coated calcium carbonate material has a median particle size (D₅₀) of no more than 2 μm.

15. The method according to claim 14, wherein the coated calcium carbonate material has a median particle size (D₅₀) ranging from 0.5 μm to 1.5 μm.

16. The method according to claim 1, wherein the coated calcium carbonate material has a total moisture content of less than 0.1% by weight relative to the dry weight of the calcium carbonate.

17. The method according to claim 1, wherein the coated calcium carbonate material has a moisture pickup of less than 0.35% by weight, relative to the total weight of the calcium carbonate.

18. The method according to claim 17, wherein the coated calcium carbonate material has a moisture pickup of less than 0.2% by weight, relative to the total weight of the calcium carbonate.

19. The method according to claim 18, wherein the coated calcium carbonate material has a moisture pickup of less than 0.1% by weight, relative to the total weight of the calcium carbonate.

20. The method according to claim 1, wherein the coated calcium carbonate has a brightness of no less than 90.

21. The method according to claim 1, wherein the at least one aliphatic carboxylic acid comprising at least 10 carbon atoms in the main chain is chosen from stearic acid, behenic acid, palmitic acid, arachidic acid, montanic acid, capric acid, lauric acid, myristic acid, isostearic acid and cerotic acid and mixtures thereof.

22. The method according to claim 1, wherein the calcium carbonate material is preheated prior to coating.

23. The method according to claim 1, wherein the at least one aliphatic carboxylic acid is present in an amount ranging from 0.8% to 1.3% by weight relative to the dry weight of the calcium carbonate material.

24. The method according to claim 1, further comprising adding into the halogen containing resin at least one additional ingredient chosen from impact modifiers, bonding agents, plasticisers, lubricants, stabilizers, anti-oxidants, ultraviolet absorbers, dyes, and colorants.

25. The method according to claim 24, wherein the at least one additional ingredient comprises one or more impact modifiers.

26. The method according to claim 25, wherein the impact modifiers are chosen from acrylic, methacrylate-styrene-butadiene, and chlorinated polyethylene based impact modifiers.

27. The method according to claim 25, wherein the impact modifiers are present in an amount ranging from 1 phr to 6 phr.

28. The method according to claim 1, wherein the calcium carbonate material is present in a loading level of at least 10% by weight, relative to the total weight of the halogen containing resin.

29. The method according to claim 28, wherein the calcium carbonate material is present in a loading level of at least 20% by weight, relative to the total weight of the halogen containing resin.

30. The method according to claim 29, wherein the calcium carbonate material is present in a loading level of at least 40% by weight, relative to the total weight of the halogen containing resin.

31. The method according to claim 30, wherein the calcium carbonate material is present in a loading level of at least 75% by weight, relative to the total weight of the halogen containing resin.

32. The method according to claim 1, wherein the halogen containing resin comprises polyvinyl chloride.

33. The method of claim 1, further comprising extruding the filled resin to form a rigid PVC product.

34. The method according to claim 33, wherein said extruding is performed with a single screw extruder or a twin-screw extruder.

35. The method according to claim 33, wherein the PVC product comprises pipes or fittings for carrying fluids.

36. The method according to claim 33, wherein the PVC product is an extruded strip.

37. The method according to claim 36, wherein the polymer product is vinyl siding.

38. The method according to claim 36, wherein the extruded strip has a thickness of no more than 0.1 inches.

39. A method of making a filled polymer product comprising:
coating a calcium carbonate material with at least one aliphatic carboxylic acid comprising at least 10 carbon atoms in the main chain to form a hydrophobic coating thereon,
adding the coated calcium carbonate material to a halogen containing resin to form a filled resin,
wherein said coated calcium carbonate material has a +325 mesh residue level of no more than 0.01%, and
wherein said method optionally comprises forming the filled resin into a plastic product.

40. A method of making a filled polymer product comprising:
coating a calcium carbonate material with at least one aliphatic carboxylic acid comprising at least 10 carbon atoms in the main chain to form a hydrophobic coating thereon,
adding the coated calcium carbonate material to a halogen containing resin to form a filled resin,
wherein said coated calcium carbonate material has a +500 mesh residue level of no more than 0.005%, and
wherein said method optionally comprises forming the filled resin into a plastic product.

41. A method of making a filled polymer product comprising:
coating a calcium carbonate material with at least one aliphatic carboxylic acid comprising at least 10 carbon atoms in the main chain to form a hydrophobic coating thereon,
adding the coated calcium carbonate material to a halogen containing resin to form a filled resin,
wherein said coated calcium carbonate material has a top size of no more than 10 μm, and
wherein said method optionally comprises forming the filled resin into a plastic product.
